(19) United States
(12) Patent Application Publication
(10) Pub. No.: US 2024/0409779 A1
(43) Pub. Date: Dec. 12, 2024

(54) MOISTURE CURABLE ADHESIVE COMPOSITION

(71) Applicants: Patil VISHAL, Dublin, OH (US); Arkema France, Colombes (FR)

(72) Inventors: Patil VISHAL, Dublin, OH (US); Xianping WANG, Dublin, OH (US)

(21) Appl. No.: 18/697,762

(22) PCT Filed: Oct. 6, 2022
(86) PCT No.: PCT/US2022/045885

§ 371 Date: Apr. 2, 2024

Related U.S. Application Data
(60) Provisional application No. 63/270,301, filed on Oct. 21, 2021.

(51) Int. Cl. C09J 7/32; C09J 5/02; C09J 175/04

(52) U.S. Cl. CPC C09J 7/32; C09J 5/02; C09J 175/04; C09J 2301/312; C09J 2301/414; C09J 2301/50; C09J 2499/006

(57) ABSTRACT

A moisture curable adhesive composition for bonding a first substrate and a second substrate wherein the adhesive composition comprising a polyurethane adhesive composition comprising an isocyanate terminated urethane prepolymer, which is a reaction product of at least one isocyanate containing compound and at least one polyether polyol triblock copolymer having a weight average molecular weight below 4,000 Dalton, is disclosed in the present disclosure. Also disclosed a moisture curable adhesive composition comprising the polyurethane adhesive composition of the present disclosure and a primer composition.

### CROSS-REFERENCE TO RELATED APPLICATIONS

This application is a U.S. national stage application under 35 U.S.C. § 371 of international application number PCT/US2022/045885 filed 6 Oct. 2022, which claims priority to patent application number U.S. 63/270,301, filed 22 Oct. 2021.

### FIELD OF THE INVENTION

The presently disclosed process(es), procedure(s), method(s), product(s), result(s), and/or concept(s) (collectively referred to hereinafter as the “present disclosure”) relates generally to a moisture cure adhesive composition and a method of bonding different or similar substrates by using the adhesive composition. The present disclosure further relates to a primer composition used along with the present moisture cure adhesive composition.

### BACKGROUND OF THE INVENTION

Structural adhesives are typically used for strong and robust structural bonding in industrial applications. Structural wood adhesives play a very significant role in the efficient utilization of wood resources. For thousands of years, woods have bonded by using natural adhesives (bio-adhesives). In the 20th century, synthetic adhesives gradually took over because they were more effective, low-cost and have better adjustable properties. Synthetic wood adhesives are based on four main synthetic thermosetting resins: phenol formaldehyde (PF), urea formaldehyde (UF), melamine-formaldehyde (MF) and polymeric diphenylmethane diisocyanate (pMDI) resins. The formaldehyde-based wood adhesives are typically allied with formaldehyde emissions. Thus, concern about formaldehyde emissions from engineered wood products, especially in indoor applications has been the most important driving factor for safe adhesive systems. Introduction of polyurethane based adhesive systems have proven to provide a reliable alternative to these formaldehyde-based wood adhesives. No formaldehyde emissions, solvent free and fast curing at room temperature are some of the reasons, the polyurethane based adhesives have continuously experienced increasing acceptance and demand in the structural wood adhesives industry. Further, the polyurethane based structural wood adhesives offer a unique characteristic because of the wide variation in physical properties that can be achieved by modifying their formulation.

The polyurethane-adhesives are available as one and two-components adhesives. The most promising ones are one component polyurethane adhesives (IC-PUR). The first one component adhesives entered the engineered wood timber market is PURBOND HB 110 (Purbond AG/Switzerland). The IC-PUR have captured a large market share as they offer several benefits to the traditional adhesives systems such as no prior mixing, reduced press time, fast bonding at room temperature, ductile and invisible bondline and the like. Nevertheless, there are still obstacles that impede a more extended use of 1C-PUR such as performance of 1C-PUR bonded wood under high thermal loads and under high moisture load. The resistance against moisture and heat remains as one of the major issues preventing 1C-PUR from being used for structural bonding of wood at a large scale.

U.S. Pat. No. 9,649,826 teaches an adhesive system for preparing lignocellulosic composites. The adhesive system comprises an aqueous primer composition and a polyurethane adhesive composition. The aqueous primer composition consists of water, up to 10 wt. % of surfactant, from 0 to 25 wt. % of a polyol having a molecular weight less than 5000 Daltons and from 0 to 10 wt. % of a co-solvent. The polyols include water soluble polyols, water dispersible polyols, or water emulsifiable polyols. Similarly, the surfactants include water soluble surfactants or water emulsifiable surfactants.

Similarly, United States Patent Publication No. 20160168435 teaches an adhesive system comprised of a primer composition and a polyurethane adhesive composition for preparing lignocellulosic composites. The primer composition is mainly comprised of polyalkylene glycols, polyalkylene glycol mono-ethers and polyalkylene glycol di-ethers having a hydroxyl number of less than or equal to 30 mg KOH/g. The primer composition may further comprise surfactants chosen from siloxane-based surfactants; alkyl polyglucosides; alkoxylated fatty acids; alkoxylated alcohols; alkylsulfosuccinates; acetylenic diols; and mixtures thereof.

U.S. Pat. No. 8,829,122 teaches impact strength modifiers obtained by reaction of amphiphilic block copolymers. These impact strength modifiers are suitable for use in heat-curing epoxy resin adhesives.

Similarly, U.S. Pat. No. 8,969,511 describes special polyether block copolymers and compositions, particularly polyurethanes derived therefrom. The compositions are well suited as a reactive hot melt adhesive and/or coatings substance.

United States Patent Publication No. 20040109853 teaches about biological molecules such as proteins as components of coatings and paints comprising a biomolecule composition.

In view of the foregoing, there remains a need in the related art to provide structural adhesives, particularly polyurethane based structural adhesives with enhanced resistance to moisture and heat/fire induced delamination.

### SUMMARY OF THE INVENTION

In an aspect, the present disclosure provides a moisture curable adhesive composition for bonding a first substrate and a second substrate, the adhesive composition comprising: a polyurethane adhesive composition comprising an isocyanate terminated urethane prepolymer, which is a reaction product of at least one isocyanate containing compound and at least one polyether polyol triblock copolymer having a weight average molecular weight below 4,000 Dalton, wherein the first substrate is a lignocellulosic substrate and the second substrate comprises a lignocellulosic substrate or a non-lignocellulosic substrate. In one non-limiting embodiment of the present disclosure, the triblock copolymer is polyoxyethylene-polyoxypropylene-polyoxyethylene block polymer (PEO-PPO-PEO) or polyoxypropylene-polyoxyethylene-polyoxypropylene (PPO-PEO-PPO) block copolymer. In one non-limiting embodiment of the present disclosure, the oxyethylene (EO) and oxypropylene (PO) repeating units are present in a weight ratio of from 1:10 to 10:1. In another non-limiting embodiment of the present disclosure, the weight average molecular weight of the triblock copolymer ranges from 100 Daltons to 2000 Daltons or from 2000 Daltons to 4000 Daltons. In one non-limiting embodiment of the present disclosure, the polyurethane adhesive composition is a one component composition.

In another aspect, the present disclosure provides a moisture curable adhesive composition for bonding a first substrate and a second substrate, the adhesive composition comprising: (i) a polyurethane adhesive composition comprising an isocyanate terminated urethane prepolymer, which is a reaction product of at least one isocyanate containing compound and at least one polyether polyol triblock copolymer having a weight average molecular weight below 4,000 Dalton; and (ii) an aqueous primer composition comprising (a) from 1 wt. % to 30 wt. % of water; (b) from 20 wt. % to 50 wt. % of at least one alkyl sulfosuccinate; (c) from 20 wt. % to 50 wt. % of at least one alkyl phenol ethoxylate; and (d) from 0.1 wt. % to 3 wt. % of a flame retardant, wherein the first substrate is a lignocellulosic substrate and the second substrate comprises a lignocellulosic substrate or a non-lignocellulosic substrate. In one non-limiting embodiment of the disclosure, the aqueous primer composition comprises (i) from 10 wt. % to 30 wt. % of water; (ii) from 30 wt. % to 50 wt. % of dioctyl sodium sulfosuccinate; (iii) from 30 wt. % to 50 wt. % of ethoxylated octylphenol; and (iv) from 0.5 wt. % to 3 wt. % of monoammonium phosphate.

In yet another aspect, the present disclosure provides a method of bonding a first substrate and a second substrate, comprising (i) providing a first substrate having at least one surface and a second substrate having at least one surface, wherein the first substrate is a lignocellulosic substrate and the second substrate comprises a lignocellulosic substrate or a non-lignocellulosic substrate; (ii) applying the adhesive composition of the present disclosure to the first substrate or to the second substrates or to the both first and second substrates; (iii) contacting the composition bearing first substrate, second substrate or both the first substrate and the second substrates for bonding; and (vi) curing the adhesive composition under a pressure of 15 psi to 300 psi and for a time period of 5 min to 440 min. In one non-limiting embodiment of the present disclosure, the method step (ii) of applying the adhesive composition comprises: (i) applying the primer composition of the present disclosure to the first substrate or to the second substrate or to the both first and second substrates; and (ii) applying the polyurethane adhesive composition over the substrate treated with the primer composition.

In still another aspect, the present disclosure provides a composite article obtained by the method of present disclosure. In one non-limiting embodiment of the present disclosure, the composite article is selected from the group consisting of panels, pipes, decking materials, boards, housings, sheets, poles, straps, fencing, members, doors, shutters, awnings, shades, signs, frames, window casings, backboards, wallboards, flooring, tiles, railroad ties, forms, trays, tool handles, stalls, bedding, dispensers, staves, films, wraps, totes, barrels, boxes, packing materials, baskets, straps, slips, racks, casings, binders, dividers, walls, indoor and outdoor carpets, rugs, wovens, and mats, frames, bookcases, sculptures, chairs, tables, desks, art, toys, games, wharves, piers, boats, masts, pollution control products, septic tanks, automotive panels, substrates, computer housings, above- and below-ground electrical casings, furniture, picnic tables, tents, playgrounds, benches, shelters, sporting goods, beds, bedpans, thread, filament, cloth, plaques, trays, hangers, servers, pools, insulation, caskets, bookcovers, clothes, canes, crutches, and other construction, agricultural, material handling, transportation, automotive, industrial, environmental, naval, electrical, electronic, recreational, medical, textile, and consumer products.

### DESCRIPTION OF THE INVENTION

Before explaining at least one embodiment of the inventive concept(s) in detail by way of exemplary drawings, experimentation, results, and laboratory procedures, it is to be understood that the inventive concept(s) is not limited in its application to the details of construction and the arrangement of the components set forth in the following description or illustrated in the drawings, experimentation and/or results. The inventive concept(s) is/are capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description and should not be regarded as limiting.

Unless otherwise defined herein, scientific and technical terms used in connection with the present disclosure shall have the meanings that are commonly understood by those of ordinary skill in the art. Further, unless otherwise required by context, singular terms shall include pluralities and plural terms shall include the singular. Generally, nomenclatures utilized in connection with, and techniques of chemistry described herein are those well-known and commonly used in the art. Reactions and purification techniques are performed according to manufacturer's specifications or as commonly accomplished in the art or as described herein.

All patents, published patent applications, and non-patent publications mentioned in the specification are indicative of the level of skill of those skilled in the art to which this present disclosure pertains. All patents, published patent applications, and non-patent publications referenced in any portion of this application are herein expressly incorporated by reference in their entirety to the same extent as if each individual patent or publication was specifically and individually indicated to be incorporated by reference.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the inventive concept(s) as defined by the appended claims.

As utilized in accordance with the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, and/or the variation that exists among the study subjects. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

As used herein, the term “amphiphilic block copolymer” means a copolymer characterized by a hydrophilic block that is chemically tethered to a hydrophobic block. The amphiphilic block copolymer can be a multiblock copolymer. Suitable and non-limiting examples of such amphiphilic multiblock copolymers can include a di-block, a triblock, a tetra-block copolymer and the like.

As used herein, the term “lignocellulosic substrate” means a substrate made from woody materials such as cellulose or lignin. Further, the woody material can be a softwood or a hardwood. Suitable examples of such lignocellulosic substrates can include, but are not limited to, solid lumber, wood particle board, wood chipboard, wood-oriented strand board, waferboard, wood fiberboard, parallel strand lumber, laminated strand lumber, plywood, laminated veneer lumber, straw particle board or straw fiberboard.

In one aspect, the present disclosure provides a moisture curable adhesive composition comprising a polyurethane adhesive composition. The polyurethane adhesive composition of the present disclosure comprises an isocyanate terminated urethane prepolymer. The isocyanate terminated urethane prepolymer can be a reaction product of at least one isocyanate containing compound and at least one polyether polyol. In one non-limiting embodiment of the present disclosure, the adhesive composition can be one component composition.

The isocyanate terminated urethane prepolymer of the present disclosure have free isocyanate (NCO) groups. The urethane prepolymer having free isocyanate groups can typically be obtained from the reaction of at least one isocyanate containing compound and at least one polyether polyol. The free hydroxyl groups of the polyether polyol react with the free isocyanate groups to provide urethane prepolymer. The isocyanate terminated urethane prepolymer according to the present disclosure can have isocyanate content in an amount of from 10 wt. % to 30 wt. % or from 10 wt. % to 25 wt. %, or from 15 wt. % to 25 wt. %, or from 10 wt. % to 20 wt. %, or from 8 wt. % to 15 wt. %, based on the total weight of the urethane pre-polymer.

The polyether polyol used for preparing the isocyanate terminated urethane prepolymer of the present disclosure can be an amphiphilic block copolymer. The amphiphilic block polymer means a copolymer characterized by a hydrophilic block that is chemically tethered to a hydrophobic block.

Suitable examples of the hydrophilic block segments can include, but are not limited to, polyethylene oxide (PEO) block, polyacrylamide (PAM) block, polyester blocks, polyamide blocks, and polysaccharide blocks.

Suitable examples of the hydrophobic block segment can include, but are not limited to, polypropylene oxide (PPO) blocks, poly(methylmethacrylate) (PMMA) blocks, poly(styrene) blocks, polyvinylchloride blocks, polyethylene blocks, and polydimethylsiloxane blocks.

In one non-limiting embodiment of the present disclosure, the hydrophilic block segment can be PEO block. In another non-limiting embodiment of the present disclosure, the hydrophobic block segment can be PPO block.

Further, the polyether polyol block copolymer according to the present disclosure can be a diblock, triblock or a tetrablock copolymers. In one non-limiting embodiment of the present disclosure, the polyether polyol block copolymer can be a triblock polymer. In one non-limiting embodiment of the present disclosure, the polyether polyol triblock copolymer can be derived from ethylene oxide (EO) and propylene oxide (PO) repeating units. The polyether polyol block copolymer according to the present disclosure can be a poly(ethylene oxide)-poly(propylene oxide)-poly(ethylene oxide) block copolymer (PEO-PPO-PEO) or a poly(propylene oxide)-poly(ethylene oxide)-poly(propylene oxide) (PPO-PEO-PPO) block copolymer.

In one non-limiting embodiment of the present disclosure, the ethylene oxide (EO) and propylene oxide (PO) repeating units can be present in a weight ratio of from 1:10 to 10:1. In one embodiment of the present disclosure, the weight ratio can vary in the range of from 1:5 to 5:1 or from 1:3 to 3:1 or from 1:2 to 2:1, in certain embodiments the ratio may be up to 10:1 or up to 5:1.

The polyether polyol triblock copolymer according to the present disclosure can have a weight average molecular weight below 4,000 Daltons. In one non-limiting embodiment of the present disclosure, the weight average molecular weight of the polyether polyol block copolymer can vary in the range of from 100 Daltons to 2000 Daltons or from 2000 Daltons to 4000 Daltons. In other non-limiting embodiments, the weight average molecular weight of the polyether polyol may be less than 3000 Daltons, preferably less than 2500 Daltons. In a further example, the weight average molecular weight of the polyether polyol may be about 1000-2300 Daltons.

In terms of ratio of the weighted average molecular weight of the various blocks of the polyether polyol, preferably the ratio is no more than 2:1, more preferably no more than 1.5:1, and even more preferably no more than 1.2:1.

Another property of interest of the polyether polyol may be its HLB (hydrophilic-lipophilic balance) value. Preferably, the polyol has an HLB value of no more than 20. Specific embodiments may have HLB values in one of the following ranges: 5-20, 6-15, 7-12 or 8-10.

Commercially available polyether polyol block copolymers can be used for preparing the isocyanate terminated urethane pre-polymer of the present disclosure. For example Pluronic series of polyols commercially available from BASF or Makon series of polyols from Stepan can be used. Alternatively, the polyether polyol block copolymer can also be prepared by using methods known to persons skilled in the related art, for example, the methods as disclosed in Macromolecules 29, 6994-7002 (1996) and Macromolecules 33, 9522-9534 (2000) and J. Polym. Sci. Part B: Polym. Phys. 45, 3338-3348 (2007).

The isocyanate-containing compound used for preparing the isocyanate terminated urethane prepolymer of the present disclosure can include any isocyanate compounds, which contains two or more isocyanate groups. Further, the isocyanates can be polyisocyanates including aromatic, aliphatic, arylaliphatic polyisocynates or mixtures thereof. The polyisocyanates can be diisocyanates that include aliphatic, cycloaliphatic, aromatic or aliphatic-aromatic diisocyantes. Suitable examples of the aliphatic and cycloaliphatic diisocyanates can include, but are not limited to, ethylene diisocyanate, ethylidene diisocyanate, propylene diisocyanate, butylene diisocyanate, trimethylene diisocyanate, cyclopentylene-1,3-diisocyanate, cyclo-hexylene-1,4-diisocyanate, cyclohexylene-1,2-diisocyanate, dichlorohexa-methylene diisocyanate, furfurylidene diisocyanate, 1,4-tetramethylene diisocyanate, 1,6-hexamethylene diisocyanate, 2,2,4-trimethyl-1,6-hexamethylene diisocyanate, 1,12-dodecamethylene diisocyanate, 1-isocyanato-2-isocyanatomethyl cyclopentane, 1-isocyanato-3-isocyanato-methyl-3,5,5-trimethylcyclohexane (isophorone diisocyanate or IPDI), bis-(4-isocyanatocyclohexyl)-methane, 2,4′-dicyclohexylmethane diisocyanate, 1,3- or 1,4-bis-(isocyanatomethyl)-cyclohexane, bis-(4-isocyanato-3-methylcyclohexyl)-methane, α′,α′,α′,α′-tetramethyl-1,3- and/or -1,4-xylylene diisocyanate, 1-isocyanato-1-methyl-4 (3)-isocyanatomethyl cyclohexane, 2,4- or 2,6-hexahydrotoluylene diisocyanate, and the like.

Similarly, suitable examples of the aromatic and aliphatic-aromatic diisocyanates can include, but are not limited to, 2,4- and/or 2,6-toluene diisocyanate, diphenyl methane-2,4′- and/or 4,4′-diisocyanate (MDI); 2,2-diphenylpropane-4,4′-diisocyanate, xylylene diisocyanate, 1,4-naphthylene diisocyanate, 1,5-naphthylene diisocyanate, m-phenylene diisocyanate, p-phenylene diisocyanate, diphenyl-4,4′-diisocyanate, azobenzene-4,4′-diisocyanate, diphenylsulphone-4,4′-diisocyanate, 2,4-tolylene diisocyanate, 1-chlorobenzene-2,4-diisocyanate, 4,4′,4″-triisocyanatotriphenylmethane, 1,3,5-triisocyanato-benzene, 2,4,6-triisocyanato-toluene, 4,4′-dimethyldiphenyl-methane-2,2′,5,5-tetratetraisocyanate, and modified aromatic diisocyanates containing carbodiimide groups, urethane groups, alophanate groups, isocyanurate groups, urea groups or biuret.

In one non-limiting embodiment of the present disclosure, the isocyanate containing compound can be diphenyl methane diisocyanate (MDI). The diphenyl methane diisocyanate (MDI) can be used in monomeric form or in polymeric form. The monomeric form of MDI can comprises diphenyl methane-2, 4′-diisocyanate or diphenyl methane-4, 4′-diisocyanate or mixtures thereof. In one non-limiting embodiment of the present disclosure, isocyanate containing compound is polymeric MDI (PMDI). The polymeric MDI used in the present disclosure can have an average isocyanate functionality of at least 2. The isocyanate functionality of the polyisocyanate can vary in the range of from 2.0 to 3.0.

In addition to the polyether polyol block copolymer, the adhesive composition of the present disclosure can further comprise polyhydric alcohols or polyols. The polyols having from 2 to 15 carbons atoms can suitably be used, for example, ethylene glycol, 1,2-propylene glycol, 1,3-propylene glycol, 1,4-butane diol, 2,3-butane diol, 1,5-pentane diol, glycerol and the like. Other suitable and non-limiting examples of such polyols can also include, phosphate diol, aromatic polyols such as Catechol, Resorcinol, hydroquinone, 1,5-dihydroxynaphthalene, 2,6-dihydroxynaphthalene, 2,7-dihydroxynaphthalene, 1,6-dihydroxynaphthalene, 2,2′-biphenol, 4,4′-biphenol, Bisphenol A, Bisphenol F, Bisphenol S, Bisphenol H, Bisphenol A ethoxylates, Bisphenol A propoxylates, 2,5-bis(hydroxymethyl)furan, 3,4-bis(hydroxymethyl)furan, 2,6-pyridinedimethanol, 1,3-benzenedimethanol, 1,4-benzenedimethanol, and 1,4-benzenediethanol. The amount of such polyhydric alcohols or polyols can vary from about 0) wt. % to 40 wt. %, or from about 1 wt. % to about 40 wt. %, or from about 1 wt. % to about 10 wt. %, based on the total weight of the adhesive composition.

In one non-limiting embodiment of the present disclosure, the isocyanate-terminated urethane prepolymers can be prepared by mixing polyols; drying the polyols at the temperature of from about 80° C. to about 105° C.; adding diisocyanates at about or less than 65° C.; increasing the temperature to about 80° C. to about 105° C.; and a typical residence time at this temperature range is about one hour or until the isocyanate content (as determined by n-butyl amine titration) reaches equilibrium (or slightly lower). The reaction can be conducted under vacuum. As stated earlier, the isocyanate terminated urethane prepolymer according to the present disclosure comprises free NCO group. The free NCO containing urethane prepolymers can be obtained by reacting excess of isocyanate containing compounds with the polyether polyols or with the mixture of polyether polyols and polyhydric alcohols. In one non-limiting embodiment of the present disclosure, the molar ratio of isocyanate containing compound (NCO) to polyether polyol (OH) can vary in the range of from >1:1.

The adhesive composition according to the present disclosure may further comprise fillers. Suitable examples of fillers can include, but are not limited to, calcium carbonate, silica, barium sulfate, alumina trihydrate (ATH), clay, calcium sulfate, talcum powder, mica powder, carbon black, graphite, glass fibers, and molecular sieves. Further, the fillers can be present in an amount of from 2.0 wt. % to 10 wt. %, based on the total weight of the adhesive composition.

The adhesive composition according to the present disclosure further optionally comprises activators. Number of aliphatic and aromatic amines can be used as activators for the purpose of the present disclosure. Suitable examples of such compounds can include, but are not limited to, diaminobicyclooctane (DABCO), 2,2′-dimorpholinodiethylether (DMDEE), trimethylaminioethylethnolamine, N,N,N′,N′,N″-pentamethyldiethylenetriamine, N-ethylmorpholine, 2-methyl-2-azanorborane, and guanidines. Other examples of the activators can include, but are not limited to, organometallic compounds based on titanium, zinc, bismuth, or zirconium metals, such as, dibutyltin dilaurate, dibutyltin diacetate, stannous octoate, dibutyltin dimercaptide, zinc neodecanoate, zinc octoate, bismuth carboxylate, zirconium octoate and different ligand chemistries surrounding catalytic metal center; alkali metal salts of carboxylic acids and phenols, such as, calcium, magnesium, strontium, barium, salts of hexanoic, octanoic, naphthenic, and linolenic acid. The activators can be present in an amount of from above trace amounts to 1.0 wt. %, based on the total weight of the adhesive composition.

The adhesive composition according to the present disclosure may further comprise at least one additive and assistance based on the total weight of the adhesive composition. The amount of additives and assistance can vary in the range of from 0.01 wt. % to 5.0 wt. %, based on the total weight of the adhesive composition. The additives and assistance can be selected from the group consisting of defoamers and rheology modifiers. Suitable examples of the defoamers can include, but are not limited to, polysiloxane compounds such as polysiloxane-polyalkylene copolymers. Another suitable polysiloxane is polydimethylsiloxane. Suitable examples of the rheology modifiers can include, but are not limited to, bentonites, hectorites, silicas, attapulgite, precipitated calcium carbonate, montmorillonite, fibers, zirconates, aluminates, cellulosics, polysaccharides, and polyamides. Examples of types of silica may include colloidal as well as fumed.

In certain embodiments, the rheology modifiers may include carbon content of at least about 3% by weight. Preferably, the carbon content will include long chain carbon side groups. Rheology modifiers with the at least about 3 wt. % carbon content may function as a thickening agent, increasing the viscosity of the adhesive composition. Such modifiers may also improve the shear properties of the adhesive composition.

Optionally the adhesive composition may also include one or more surfactants. The surfactant may be a non-functional or functionalized surfactant.

The adhesive composition also may contain less than about 10 wt. % of water, preferably less than 1 wt. % of water, more preferably only trace amounts of water, even more preferably, the composition is 100% solids.

It is also preferred that the adhesive composition is a chemical reaction product and not a blend of a plurality of chemical compounds.

Optionally the adhesive composition may include a polyester polyol. The polyester polyol may be used in place of or in conjunction with the polyether polyol. In the case the polyester polyol and the polyether polyol are used in conjunction, the wt. % of the polyether polyol is at least about 5 wt. %.

Examples of suitable polyester polyols include polyglycols dicarboxylates, polycaprolactone polyols, polycaprolactone and combinations thereof. Useful polyester polyols may be prepared from the reaction product of polycarboxylic acids, their anhydrides, their esters or their halides, and a stoichiometric excess polyhydric alcohols. Suitable polycarboxylic acids include dicarboxylic acids and tricarboxylic acids including, e.g., aromatic dicarboxylic acids, anhydrides and esters thereof (e.g. terephthalic acid, isophthalic acid, dimethyl terephthalate, diethyl terephthalate, phthalic acid, phthalic anhydride, methyl-hexahydrophthalic acid, methyl-hexahydrophthalic anhydride, methyl-tetrahydrophthalic acid, methyl-tetrahydrophthalic anhydride, hexahydrophthalic acid, hexahydrophthalic anhydride, and tetrahydrophthalic acid), aliphatic dicarboxylic acids and anhydrides thereof (e.g. maleic acid, maleic anhydride, succinic acid, succinic anhydride, glutaric acid, glutaric anhydride, adipic acid, hexanoic acid, pimelic acid, suberic acid, azelaic acid, sebacic acid, chlorendic acid, 1,2,4-butane-tricarboxylic acid, decanedicarboxylic acid, octadecanedicarboxylic acid, dimeric acid, dimerized fatty acids, trimeric fatty acids, and fumaric acid), and alicyclic dicarboxylic acids (e.g. 1,3-cyclohexanedicarboxylic acid, and 1,4-cyclohexanedicarboxylic acid).

Additionally examples of suitable polyols from which polyester polyols can be derived include aliphatic polyols, e.g., ethylene glycols, propane diols (e.g., 1,2-propanediol and 1,3-propanediol), butane diols (e.g., 1,3-butanediol, 1,4-butanediol), pentane diols (e.g., 1,5-pentanediol), 1,6-hexanediol, 1,8-octanediol, 1,10-decanediol, neopentyl glycol, diethylene glycol, triethylene glycol, tetraethylene glycol, polyethylene glycols, propylene glycol, polypropylene glycols (e.g., dipropylene glycol and tripropylene glycol), 1,4-cyclohexanedimethanol, 1,4-cyclohexanediol, dimer diols, bisphenol A, bisphenol F, hydrogenated bisphenol A, hydrogenated bisphenol F, glycerol, tetramethylene glycol, polytetramethylene glycol, 3-methyl-1,5-pentanediol, 1,9-nonanediol, 2-methyl-1,8-octanediol, trimethylolpropane, glycerin, pentaerythritol, sorbitol, glucose, and combinations thereof.

Preferably, the polyester polyol may be amphiphilic also. The above properties regarding the polyether polyol are equally applicable to the polyester polyol, whether used with or without the polyether polyol.

In another aspect, the present disclosure further provides a primer composition to be applied on substrate(s) surfaces to be bonded before applying the polyurethane adhesive composition of the present disclosure. The aqueous primer composition according to the present disclosure can typically comprise (i) from 20 wt. % to 50 wt. % of at least one alkyl sulfosuccinate; (ii) from 20 wt. % to 50 wt. % of at least one alkyl phenol ethoxylates; (iii) from 0.1 wt. % to 3 wt. % of a flame retardant; and (iv) from 1 wt. % to 30 wt. % of water.

The alkylsulfosuccinate compounds that can be used for the purpose of the present disclosure can include monoester or diester sulfosuccinates. The monoester or diester sulfosuccinates of C₄ to C₁₃ can be used in the present disclosure. Suitable and non-limiting examples of diester sulfosuccinate can include ammonium dinonyl sulfosuccinate, diamyl sodium sulfosuccinate, dicapryl sodium sulfosuccinate, diheptyl sodium sulfosuccinate, dihexyl sodium sulfosuccinate, diisobutyl sodium sulfosuccinate, ditridecyl sodium sulfosuccinate, dioctyl sodium sulfosuccinate and the like. Similarly, suitable and non-limiting examples of monoester sulfosuccinate can include ammonium lauryl sulfosuccinate, diammonium lauryl sulfosuccinate, dipotassium lauryl sulfosuccinate, disodium cetearyl sulfosuccinate, disodium cetyl sulfosuccinate, disodium coco-sulfosuccinate, disodium isodecyl sulfosuccinate, disodium isostearyl sulfosuccinate, disodium lauryl sulfosuccinate, disodium oleyl sulfosuccinate, disodium stearyl sulfosuccinate, disodium tridecylsulfosuccinate and the like. In one non-limiting embodiment of the present disclosure, the alkylsulfosuccinate is dioctyl sodium sulfosuccinate. Further, the alkylsulfosuccinate can be present in an amount of from 30 wt. % to 50 wt. %, based on the total weight of the primer composition.

Similar to the optional surfactant of the adhesive, the surfactant in the primer may be a non-functional surfactant, even more preferably having no more than 2 hydroxyl units, further preferably no more than a hydroxyl unit.

In another optional embodiment, the primer may have less than an effective amount of an adhesion promoter, preferably less than about 1 wt. %, more preferably no more than trace amounts of the adhesion promoter, even more preferably substantially devoid of the adhesion promoter.

Similarly, suitable examples of the alkyl phenol ethoxylates that can be used in the primer composition of the present disclosure can include, but are not limited to, tristyrylphenol ethoxylates, polyethoxylated tallow amine, decyl alcohol ethoxylates, undecyl alcohol ethoxylates, tridecyl alcohol ethoxylates, propylheptanol alcohol ethoxylates, amide ethoxylates, cocoamine ethoxylates, nonyl phenol ethoxylates, ethoxylated octyl phenol, castor oil ethoxylates, sorbitan ester ethoxylates, tridecyl alcohol alkoxylates, tall oil fatty acid ethoxylates, lauryl alcohol ethoxylates, and ethoxylated phenol. In one non-limiting embodiment of the present disclosure, the alkyl phenol ethoxylates can be ethoxylated octylphenol. Further, the alkyl phenol ethoxylates can be present in an amount of from 30 wt. % to 50 wt. % or from 35 wt. % to 50 wt. % or from 35 wt. % to 45%, based on the total weight of the primer composition.

The water present in the aqueous primer composition of the present disclosure can be filtered water, deionized water, distilled water, pure water, tap water, treated water or any mixtures thereof. In one non-limiting embodiment of the present disclosure, the water can be present in amount of from 10 wt. % to 30 wt. % or from 15 wt. % to 25 wt. %, based on the total weight of the primer composition. In another non-limiting embodiment of the present disclosure, the water can be mixed with at least one other solvent. Suitable examples of such solvents can include, but are not limited to acetone, ethanol, methanol, and any combinations thereof.

The primer composition of the present disclosure can further comprise at least one flame retardant. Any flame retardants which are known in the related art can be used in the present primer composition. Suitable examples of the such flame retardants can include, but are not limited to, monoammonium phosphate, antimony oxide, zinc borates, aluminium hydroxides, magnesium hydroxides, chlorinated paraffins, decabromodiphenyl oxide, brominated polystyrene, decabromodiphenyl ethane, ethylene-bis-tetrabromophthalimide, tetrabromophthalate ester, brominated styrene-butadiene, hexabromocyclododecane, phosphate esters, tris(2-chloroethyl)phosphate (TCEP), tris(1-chloro-2-propyl)phosphate (TCPP), tris(1,3-dichloro-2-propyl)phosphate (TDCP), ammonium polyphosphates, melamine polyphosphate, polyphosphonates, polyphosphazine, expandable graphite, phenolics, graphene, and fullerenes. In one non-limiting embodiment of the present disclosure, the flame retardant is monoammonium phosphate. The amount of the flame retardant can vary in the range of from 0.1 wt. % to 3 wt. % or from 0.5 wt. % to 2.5 wt. %, based on the total weight of the primer composition.

The aqueous primer composition of the present of the present disclosure can have pH in the range of from 4 to 8 or from 5 to 7.

The aqueous primer composition of the present disclosure can be prepared by blending various ingredients. The aqueous primer composition according to the present disclosure can be present in solution form. The aqueous primer composition of the present invention can be used as such or can be diluted further just before the application. In one non-limiting embodiment of the present disclosure, the diluted form of the primer composition can comprise from 0.5 wt. % to 9 wt. % of the primer composition, based on the total weight of the diluted form the primer composition.

Another aspect of the present disclosure relates to a method of bonding at least two substrates by using the moisture cure adhesive composition of the present disclosure. The method according to the present disclosure can comprise the steps of: (i). providing a first substrate having at least one surface and a second substrate having at least one surface; (ii) applying the moisture adhesive composition of the present disclosure to at least one surface of the first substrate or to at least one surface of the second substrate or to the both first and second substrates; (iii) contacting the composition bearing first substrate or second substrate or both the first substrate and second substrate for bonding; and (iv) curing the moisture cure adhesive composition. The moisture adhesive composition according to the present disclosure can be applied to one substrate or both the substrates. The substrates are then joined to form an adhesive bond. In general, the substrates should be joined as per recommended assembly time instructions given in technical literature of adhesive that includes open assembly time, close assembly time and press time. Typical assembly time for the adhesive is between less than 1 min to as long as 75 minute. Further, adhesive composition of the present disclosure can be cured in a conventional manner, for example, at ambient temperature or elevated temperature and under pressure. The curing typically involves applying a pressure of about 15 psi to 300 psi using appropriate press time period of about 5 minutes to typically no more than about 440 minutes to enable the formation of strong adhesive bond. Examples of suitable pressures may range from 50 to 220 psi, 60-200 psi, 60-190 psi, 90-185 psi or 60-90 psi. The press time can vary based on adhesive press time recommendation, for example, the type and amount of activators or catalysts being used in the present adhesive composition. Further, heat can also be applied along with pressure to accelerate the curing of the present adhesive composition.

In another non-limiting embodiment of the present disclosure, the method of bonding first substrate and second substrate can also comprise a method step of applying the primer composition to the first substrate or to the second substrate or to the both first and second substrates before applying the polyurethane adhesive composition of the present disclosure. The application of the adhesive composition on the substrate surface according to the present disclosure can be carried out using conventional methods known in the related art, for example, a brushing, a spraying or a coating technique.

The adhesive composition according to the present disclosure can be applied immediately after the primer application or can be applied after a certain timer interval. In one non-limiting embodiment of the present disclosure, the adhesive composition can be applied immediately after the primer application on the substrates. In another non-limiting embodiment of the present disclosure, the adhesive composition can be applied within 24 hours to 7 days of the primer application on the substrate.

The first and second substrate as used herein in the present disclosure can be made of same or different material. The first substrate used in the present disclosure can be a lignocellulosic substrate whereas the second substrate used in the present disclosure can be a lignocellulosic substrate or a non-lignocellulosic substrate. The lignocellulosic substrates as used in the present method of bonding means a substrate made from woody materials such as cellulose and lignin. The lignocellulosic substrates can be chosen from softwood or hardwood species. Suitable examples of such lignocellulosic substrates can include, but are not limited to, solid lumber wood particle board, wood chipboard, wood-oriented strand board, waferboard, wood fiberboard, parallel strand lumber, laminated strand lumber, plywood, laminated veneer lumber, straw particle board or straw fiberboard. Similarly, suitable examples of the non-lignocellulosic substrate can include, but are not limited to, alloys, glass, ceramics, foams, plastics, composites, metals, bovine or equine hoof.

In one embodiment of the present disclosure, the substrate can be pretreated before applying the adhesive. Such pre-treatments can include, physical look and/or cleaning methods, applying an adhesive promoter, an adhesive promoter solution or a primer.

The method of bonding the first substrate and the second substrate according to the present disclosure results in a composite article. The composite articles are in particular a structure, for example, panels, pipes, decking materials, boards, housings, sheets, poles, straps, fencing, members, doors, shutters, awnings, shades, signs, frames, window casings, backboards, wallboards, flooring, tiles, railroad ties, forms, trays, tool handles, stalls, bedding, dispensers, staves, films, wraps, totes, barrels, boxes, packing materials, baskets, straps, slips, racks, casings, binders, dividers, walls, indoor and outdoor carpets, rugs, wovens, and mats, frames, bookcases, sculptures, chairs, tables, desks, art, toys, games, wharves, piers, boats, masts, pollution control products, septic tanks, automotive panels, substrates, computer housings, above- and below-ground electrical casings, furniture, picnic tables, tents, playgrounds, benches, shelters, sporting goods, beds, bedpans, thread, filament, cloth, plaques, trays, hangers, servers, pools, insulation, caskets, bookcovers, clothes, canes, crutches, and other construction, agricultural, material handling, transportation, automotive, industrial, environmental, naval, electrical, electronic, recreational, medical, textile, or consumer products.

In still another aspect, the present disclosure provides composite articles obtained from the method of bonding as herein above described. The composite articles according to the present disclosure meets the requirement of Canadian Standard Association (CSA) Standard O112.9 and PRG-320 for CLT application.

### ASPECTS OF THE DISCLOSURE

Aspect 1. A moisture curable adhesive composition for bonding a first substrate and a second substrate, the adhesive composition comprising:
a polyurethane adhesive composition comprising an isocyanate terminated urethane prepolymer, which is a reaction product of at least one isocyanate containing compound and at least one amphiphilic copolymer having a weight average molecular weight of below about 4000 Dalton, and a non-functional surfactant;
wherein the first substrate is a lignocellulosic substrate and the second substrate comprises a lignocellulosic substrate or a non-lignocellulosic substrate.

Aspect 2. The moisture curable adhesive composition of aspect 1 wherein the amphiphilic copolymer comprises a polyether polyol triblock.

Aspect 3. The moisture curable adhesive composition of either aspect 1 or 2 further comprising a silica rheology modifier.

Aspect 4. The moisture curable adhesive composition of anyone of the preceding aspects wherein the weight average molecular weight comprises no more than about 3000 Daltons.

Aspect 5. The moisture curable adhesive composition of anyone of the preceding aspects 2-4 wherein prepolymer comprises one or more aromatic polyols in combination with the triblock.

Aspect 6. The moisture curable adhesive composition of aspect 5 wherein the molecular weight comprises no more than about 2500 Daltons.

Aspect 7. The moisture curable adhesive composition of anyone of the preceding aspects 2-6 wherein the triblock copolymer is poly(ethylene oxide)-poly(propylene oxide)-poly(ethylene oxide) block polymer (PEO-PPO-PEO) or poly(propylene oxide)-poly(ethylene oxide)-poly(propylene oxide) (PPO-PEO-PPO) block copolymer and an ethylene oxide (EO) and propylene oxide (PO) repeating units are present in a weight ratio of from 1:10 to 10:1.

Aspect 8. The moisture curable adhesive composition of aspect 7 wherein the weight ratio comprises 1:5 to 5:1.

Aspect 9. The moisture curable adhesive composition of anyone of the preceding aspects 2-8 wherein a molar ratio of isocyanate containing compound (NCO) to polyether polyol (OH) comprises >1:1.

Aspect 10. A moisture curable adhesive composition for bonding a first substrate and a second substrate, the adhesive composition comprising:
a polyurethane adhesive composition comprising an isocyanate terminated urethane prepolymer, which is a reaction product of at least one isocyanate containing compound and at least one amphiphilic copolymer having a weight average molecular weight of below 4,000 Dalton, and a silica based rheology modifier
wherein the first substrate is a lignocellulosic substrate and the second substrate comprises a lignocellulosic substrate or a non-lignocellulosic substrate.

Aspect 11. The moisture curable adhesive composition of aspect 10 wherein the amphiphilic copolymer comprises a polyether polyol triblock.

Aspect 12. The moisture curable adhesive composition of anyone of the preceding aspects 10 or 11 wherein the weight average molecular weight comprises no more than 3000 Daltons.

Aspect 13. The moisture curable adhesive composition of anyone of the preceding aspects 11 or 12 wherein the copolymer is poly(ethylene oxide)-poly(propylene oxide)-poly(ethylene oxide) block polymer (PEO-PPO-PEO) or poly(propylene oxide)-poly(ethylene oxide)-poly(propylene oxide) (PPO-PEO-PPO) block copolymer and an ethylene oxide (EO) and propylene oxide (PO) repeating units are present in a weight ratio of from 1:10 to 10:1.

Aspect 14. The moisture curable adhesive composition of aspect 13 wherein the weight ratio comprises 1:5 to 5:1

Aspect 15. The moisture curable adhesive composition of anyone of the preceding aspects 10-14 wherein a molar ratio of isocyanate containing compound (NCO) to polyether polyol (OH) comprises >1:1.

Aspect 16. The moisture curable adhesive composition of anyone of the preceding aspects 10-14 wherein the at least one amphiphilic copolymer further comprises a polyester polyol.

Aspect 17. The moisture curable adhesive composition of aspect 16 wherein the polyester polyol comprises no more than 50 wt. % of the amphiphilic copolymer.

Aspect 18. A moisture curable adhesive composition for bonding a first substrate and a second substrate, the adhesive composition comprising:
a polyurethane adhesive composition comprising a non-functional surfactant and a silica based rheology modifier;
wherein the first substrate is a lignocellulosic substrate and the second substrate comprises a lignocellulosic substrate or a non-lignocellulosic substrate.

Aspect 19. The moisture curable adhesive composition of aspect 18 wherein the silica based rheology modifier has a carbon content of at least about 3 wt. %.

### EXAMPLES

Unless indicated otherwise, the following test methods were utilized in the Examples that follows.

Primer 1 consists of 100% Tween 20 (Polyethylene glycol sorbitan monolaurate).

Primer 2 consists of 100% Toximul TA-20 (ethoxylated tallow amines).

Primer 3 consists of 100 wt. % Ninol C-5 (PEG-6 coconut DEA amide).

Primer 4 consists of 100 wt. % Aerosol OT-75 (diluted solution of sodium dioctyl sulfosuccinate).

Primer 5: Primer consists of 100 wt. % Dextrol OC-180 (potassium salt form of an ethoxylated aliphatic alcohol phosphate ester).

Primer 6: Primer consists of 100 wt. % Igepal CA-897 (octylphenol ethoxylates (non-ionic surfactant))

Primer 7: Primer consists of 45 wt. % Igepal CA897 (octylphenol ethoxylates (non-ionic surfactant)), 35 wt. % OT-75, 1.05 wt. % Monoammonium phosphate, and 18.95 wt. % water

Adhesive A comprises of methylene diisocyanate (MDI) based prepolymer containing PPG type of polyol being characterized by 16-18% NCO content and viscosity between 20,000 to 30,000 cP (average viscosity as recorded by rheometer with varying shear rate 0.1 sec⁻¹ to 10 sec⁻¹ at 25° C.)

Adhesive B comprises of methylene diisocyanate (MDI) based prepolymer containing PPG-PEG-PPG triblock polyol (Pluronic 10R5) characterized by 16-18% NCO content and viscosity of 20,000 to 30,000 cP.

Adhesive C comprises of methylene diisocyanate (MDI) based prepolymer containing PEG-PPG-PEG triblock polyol (Pluronic L-35) characterized by 16-18% NCO content and viscosity between 20,000 to 30,000 cP.

Adhesive D comprises of methylene diisocyanate (MDI) based prepolymer containing PEG-PPG-PEG triblock polyol (Pluronic L-64) characterized by 16-18% NCO content and viscosity of 20,000 to 30,000 cP.

Adhesive E comprises of methylene diisocyanate (MDI) based prepolymer containing PPG-PEG-PPG triblock polyol (Pluronic 10R5) in combination of aromatic polyol characterized by 16-18% NCO content and viscosity of 20,000 to 30,000 cP.

Adhesive F comprises of methylene diisocyanate (MDI) based prepolymer containing PPG-PEG-PPG triblock polyol (Pluronic 10R5) in combination of aromatic polyol characterized by 17-20% NCO content and viscosity of 20,000 to 30,000 cP.

The triblock polyols used in adhesives B-F all had a weight average molecular weight of below 4,000 Dalton.

Table 1 shows molecular weight and polydispersity index (PDI) of adhesive A and adhesive E.

TABLE 1

| Adhesive | Mn | Mw | PDI |
|---|---|---|---|
| E type | 3876 | 6035 | 1.56 |
| A type | 6770 | 11558 | 1.71 |

Mn: Number Average Molecular Weight
Mw: Weighted Average Molecular Weight
PDI: Mw/Mn

### Example 1

Primer 1 was applied at spread rate of 2 g/sqft to Southern Yellow Pine wood boards for CLT (cross laminated timber) lamination. After 30 min, adhesive A, B, C and D were applied at 24 g/sqft spread rate on primed boards. After gluing surfaces together, bonded wood boards were pressed at 125 psi for at least 4 hours before press was released. Glued samples were stored for 7 days at room temperature to allow full cure. Samples were cut into small pieces and subjected to delamination study according to AITC Test T110 and % delamination (“Delam”) were recorded. Also, wood failure % were measured based on CSA 0112.9 test norms on step shears. Results are shown in Table 2.

TABLE 2

| Adhesive | A | B | C | D |
|---|---|---|---|---|
| Primer | 1 | 1 | 1 | 1 |
| % Delam | 17.1 | 1.1 | 1.9 | 1.1 |
| % Wood Failure, wet | 28 | 76 | 60 | 84 |

The results indicate that incorporation of amphiphilic block polyol of PEG and PPG in MDI based prepolymer shows lower % delamination and higher % wood failure when compared to PPG type of polyol.

### Example 2

Adhesive E was applied at 24 g/sqft spread rate on Southern Yellow Pine wood boards with and without primer 1. After gluing surfaces together, bonded wood boards were pressed at 125 psi for at least 4 hours before press was released. Glued samples were stored for 7 days at room temperature to allow full cure. Samples were cut into small pieces and subjected to delamination study according to AITC Test T110 and % delamination were recorded. Also, wood failure % were measured based on CSA 0112.9 test on step shears. Results are shown in Table 3.

TABLE 3

| Adhesive | E | E |
|---|---|---|
| Primer | NA | 1 |
| % Delam | 6 | 0.0 |
| % Wood Failure, wet | 35 | 92.5 |

Result indicate that the adhesive system shows higher % delam and lower wood failure % when primer was not applied.

### Example: 3

Primer 1, 2, 3, 4, 5, 6 were applied at spread rate of 2 g/sqft to Southern Yellow Pine wood boards for CLT (cross laminated timber) lamination. After 30 min, adhesive E was applied at 24 g/sqft spread rate on primed wood boards. After gluing surfaces together, bonded wood boards were pressed at 125 psi for at least 4 hours before press was released. Glued samples were stored for 7 days at room temperature to allow full cure. Samples were cut into small pieces and subjected to delamination study according to AITC Test T110 and % delamination were recorded. Also, wood failure % were measured based on CSA 0112.9 test on step shears. Results are shown in Table 4.

TABLE 4

| Adhesive | E | E | E | E | E | E |
|---|---|---|---|---|---|---|
| Primer | 1 | 2 | 3 | 4 | 5 | 6 |
| % Delam | 0.0 | 2.8 | 4.7 | 0.6 | 0.2 | 0.2 |
| % wood failure, wet | 87 | 90 | 83 | 81 | 84 | 90 |

Results indicate that wide variety of primers can be used to achieve low % delam and high % wood failure. These include anionic non-reactive surfactants and non-ionic reactive surfactants.

### Example 4

Primer 7 was applied at spread rate of 2 g/sqft to Black Spruce, Douglas Fir and Southern Yellow Pine boards for CLT (cross laminated timber) lamination. After 30 min, adhesive F was applied at 24 g/sqft spread rate on primed wood boards. After adhering the surfaces together, bonded wood boards were pressed at 150 psi for at least 4 hours before press was released. The adhered samples were stored for 7 days at room temperature to allow full cure. Samples were cut into small pieces and subjected to cyclic delamination testing according to AITC Test T110 and % delamination were recorded. Also, wood failure % were measured based on vacuum-pressure test as described in section 5.5.3.3 of CSA 112.9-10 on step shears. Results are shown in Table 5.

TABLE 5

| Wood species | Black spruce | Douglas Fir | Southern Yellow Pine |
|---|---|---|---|
| Adhesive | F | F | F |
| Primer | 7 | 7 | 7 |
| % Delam | 0.2 | 2.5 | 0.0 |
| % wood failure, | 87 | 76 | 96 |
| vacuum | | | |

1. A moisture curable adhesive composition for bonding a first substrate and a second substrate, the adhesive composition comprising:
a polyurethane adhesive composition comprising an isocyanate terminated urethane prepolymer, which is a reaction product of at least one isocyanate containing compound and at least one polyether polyol triblock copolymer having a weight average molecular weight of below 4,000 Dalton, wherein the urethane prepolymer has an isocyanate containing compound in an amount of from 10 wt. % to 30 wt. %, based on the total weight of the pre-polymer,
wherein the first substrate is a lignocellulosic substrate and the second substrate comprises a lignocellulosic substrate or a non-lignocellulosic substrate.

2. The adhesive composition of claim 1, wherein the lignocellulosic substrate comprises a wood particle board, wood chipboard, wood-oriented strand board, waferboard, wood fiberboard, parallel strand lumber, laminated strand lumber, plywood, laminated vencer lumber, straw particle board or straw fiberboard.

3. The adhesive composition of claim 1, wherein the non-lignocellulosic substrate is selected from the group consisting of foams, plastics, composites, metals, bovine and equine hoof.

4. The adhesive composition of claim 1, wherein the triblock copolymer is poly(ethylene oxide)-poly(propylene oxide)-poly(ethylene oxide) block polymer (PEO-PPO-PEO) or poly(propylene oxide)-poly(ethylene oxide)-poly(propylene oxide) (PPO-PEO-PPO) block copolymer.

5. The adhesive composition of claim 1, wherein the weight average molecular weight of the triblock copolymer ranges from 100 Daltons to 2000 Daltons or from 2000 Daltons to 4000 Daltons.

6. The adhesive composition of claim 4, wherein the ethylene oxide (EO) and propylene oxide (PO) repeating units are present in a weight ratio of from 1:10 to 10:1, preferably 5:1 to 1:5.

7. (canceled)

8. The adhesive composition of claim 1, wherein the molar ratio of isocyanate containing compound (NCO) to polyether polyol (OH) is in the range of from >1:1.

9. The adhesive composition of claim 1, wherein the isocyanate containing compound is selected from the group consisting of diphenyl methane-2,4′-diisocyanate or diphenyl methane-4,4′-diisocyanate, polymeric diphenylmethane diisocyanates or mixtures thereof.

10. The adhesive composition of claim 1, wherein the polyurethane adhesive composition is a one component composition.

11. The adhesive composition of claim 1, further optionally comprises at least one polyol selected from the group consisting of polypropylene glycol, phosphate polyols, and aromatic polyols.

12. The adhesive composition of claim 1, further comprises (i) from 2.0 wt. % to 10 wt. % of a filler based on the total weight of the adhesive composition; (ii) from 0.01 wt. % to 5.0 wt. % of at least one additive and assistance based on the total weight of the adhesive composition; and (iii) from 0 wt. % to 1 wt. % of an activator based on the total weight of the adhesive composition.

13. A moisture curable adhesive composition for bonding a first substrate and a second substrate, the adhesive composition comprising:
(i) a polyurethane adhesive composition comprising an isocyanate terminated urethane prepolymer, which is a reaction product of at least one isocyanate containing compound and at least one polyether polyol triblock copolymer having a weight average molecular weight below 4,000 Dalton; and
(ii) an aqueous primer composition comprises (i) from 1 wt. % to 30 wt. % of water; (ii) from 20 wt. % to 50 wt. % of alkyl sulfosuccinate; (iii) from 20 wt. % to 50 wt. % of alkoxylated phenol; and (iv) from 0.1 wt. % to 3 wt. % of a flame retardant,
wherein the first substrate is a lignocellulosic substrate and the second substrate comprises a lignocellulosic substrate or a non-lignocellulosic substrate.

14. The adhesive composition of claim 13, wherein the aqueous primer composition comprises (i) from 10 wt. % to 30 wt. % of water; (ii) from 30 wt. % to 50 wt. % of dioctyl sodium sulfosuccinate; (iii) from 30 wt. % to 50 wt. % of ethoxylated octylphenol; and (iv) from 0.5 wt. % to 3 wt. % of monoammonium phosphate.

15. The adhesive composition of claim 13, wherein the aqueous primer composition has pH in the range of from 6 to 8.

16. The adhesive composition of claim anyone of claim 13, wherein the polyurethane adhesive composition is a one component composition.

17. A method of bonding a first substrate and a second substrate, comprising
(i) providing a first substrate having at least one surface and a second substrate having at least one surface, wherein the first substrate is a lignocellulosic substrate and the second substrate comprises a lignocellulosic substrate or a non-lignocellulosic substrate
(ii) applying the adhesive composition of claim 1 or claim 13 to the first substrate or to the second substrates or to the both first and second substrates,
(iii) contacting the composition bearing first substrate, second substrate or both the first substrate and the second substrates for bonding; and
(vi) curing the adhesive composition at a pressure of at least about 15 psi to 300 psi and for a time period of at least about 5 min.

18. The method of claim 17, wherein the method step (ii) of applying the adhesive composition comprises:
(i) applying a primer composition to the first substrate or to the second substrate or to the both first and second substrates; and
(ii) applying the polyurethane adhesive composition over the substrate treated with the primer composition.

19. A composite article obtained by the method of claim 17.

20. The composite article of claim 19, is selected from the group consisting of panels, pipes, decking materials, boards, housings, sheets, poles, straps, fencing, members, doors, shutters, awnings, shades, signs, frames, window casings, backboards, wallboards, flooring, tiles, railroad ties, forms, trays, tool handles, stalls, bedding, dispensers, staves, films, wraps, totes, barrels, boxes, packing materials, baskets, straps, slips, racks, casings, binders, dividers, walls, indoor and outdoor carpets, rugs, wovens, and mats, frames, bookcases, sculptures, chairs, tables, desks, art, toys, games, wharves, piers, boats, masts, pollution control products, septic tanks, automotive panels, substrates, computer housings, above- and below-ground electrical casings, furniture, picnic tables, tents, playgrounds, benches, shelters, sporting goods, beds, bedpans, thread, filament, cloth, plaques, trays, hangers, servers, pools, insulation, caskets, bookcovers, clothes, canes, crutches, and other construction, agricultural, material handling, transportation, automotive, industrial, environmental, naval, electrical, electronic, recreational, medical, textile, and consumer products.

21. The composite article of claim 19 which meets the requirement of Canadian Standard Association (CSA) Standard O112.9 and PRG-320 for CLT application.

22. (canceled)
